(19) United States
(12) Patent Application Publication
(10) Pub. No.: US 2026/0331069 A1
(43) Pub. Date: Oct. 22, 2026

(54) METHODS AND APPARATUSES FOR ENERGY-SAVING VIDEO PROCESSING

(71) Applicant: DRNC Holding, Inc., Wilmington, DE (US)

(72) Inventor: William REDMANN, Glendale, CA (US)

(21) Appl. No.: 19/481,164

(22) PCT Filed: Apr. 30, 2024
(86) PCT No.: PCT/US2024/027009

§ 371 Date: Nov. 3, 2025

Related U.S. Application Data
(60) Provisional application No. 63/463,924, filed on May 4, 2023.

(51) Int. Cl. G09G 3/34; G09G 3/36

(52) U.S. Cl. CPC G09G 3/342; G09G 3/36; G09G 2320/0686; G09G 2330/023; G09G 2354/00

(57) ABSTRACT

Procedures, methods, architectures, apparatuses, systems, devices, and computer program products for energy-saving video processing. A device comprises an image processor, configured to receive a first video and produce a display-configured second video for a display, the second video based on the first video and including a set of pixels, and a display driver, configured to receive the second video and transform the second video into drive signals for the display based on an active energy mode set by a selector in the device, the display driver having a plurality of selectable energy modes, the plurality of energy modes comprising at least one reduced-energy mode and a non-reduced energy mode, each of the at least one reduced-energy mode blanking a subset of the pixels when selected, the display driver blanking no pixels when the non-reduced energy mode is selected.

### CROSS-REFERENCE TO RELATED APPLICATIONS

This application claims the benefit of U.S. Provisional Application No. 63/463,924, filed 4 May 2023, which is incorporated herein by reference in their entirety.

### BACKGROUND

The present disclosure is generally directed to the fields of communications, software and encoding, including, for example, to methods, architectures, apparatuses, systems directed to energy-saving video processing.

### SUMMARY

In a first aspect, the present principles are directed to a device comprising an image processor, configured to receive a first video and produce a display-configured second video for a display, the second video based on the first video and including a set of pixels, and a display driver, configured to receive the second video and transform the second video into drive signals for the display based on an active energy mode set by a selector in the device, the display driver having a plurality of selectable energy modes, the plurality of energy modes comprising at least one reduced-energy mode and a non-reduced energy mode, each of the at least one reduced-energy mode blanking a subset of the pixels when selected, the display driver blanking no pixels when the non-reduced energy mode is selected.

In a second aspect, the present principles are directed to a method performed by a device, the method comprising producing a display-configured second video for a display, the second video based on a received first video and including a set of pixels, and transforming the second video into drive signals for the display based on a set active energy mode selected from a plurality of selectable energy modes comprising at least one reduced-energy mode and a non-reduced energy mode, each of the at least one reduced-energy mode blanking a subset of the pixels when selected, the non-reduced energy mode blanking no pixels when selected.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1 is a system diagram illustrating an example of a video system according to an embodiment of the present principles;

FIG. 2 illustrates a block diagram for one example embodiment an end-user device according to the present principles;

FIGS. 3A and 3B illustrate flow charts of three related methods according to the present principles in different ways;

FIG. 4 illustrates example display driver blanking patterns that reduce energy consumption for a display matrix;

FIG. 5 illustrates a block diagram for an example display driver of the prior art;

FIG. 6 illustrates a block diagram for an example display driver with an energy-reducing blanking circuit of the present principles; and

FIG. 7 illustrates a table of example energy-reducing blanking modes of the present principles.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

Most of the time, sufficient electric power is available in developed areas. However, in most of these places, there are occasional events where the quantity of available electric power is insufficient to meet the full demand. If unmanaged, this could cause widespread blackouts (i.e., the electric grid fails and electric power is interrupted), brownouts (i.e., a below-nominal delivery voltage is provided), or “load shedding” (i.e., segments of the grid are deliberately shut off in order to keep the remainder of the grid operational, often on a periodic basis often called “rolling blackouts”).

Techniques have been introduced where systems managing the grid signal a “demand response” (DR) event as a mechanism to forestall the more severe interruptions. The U.S. Federal Energy Regulatory Commission defines “demand response” as “changes in electric usage by demand-side resources from their normal consumption patterns in response to changes in the price of electricity over time, or to incentive payments designed to induce lower electricity use at times of high wholesale market prices or when system reliability is jeopardized.”

Typically, large scale power users, such as factories or large buildings (e.g., skyscrapers), are equipped with systems able to receive a DR signal and operate automatically, or even with manual intervention, to reduce their power consumption for the duration of the event. The reaction of such a system to a DR event could be to shut down energy-hungry processes (e.g., electric furnaces, large conveyor systems) or turn off or turn down less critical appliances (e.g., air conditioner thermostats could be raised a few degrees). In some cases, the DR signal is merely a change in pricing for electricity, and systems that can react quickly to price changes adapt accordingly.

Historically, there have been many systems developed to signal that the electric utility is under stress and that less power should be consumed. A drawback of early versions of these systems has been that they were not standardized or interoperable. More recently, standards that support broad interoperability have emerged, for example those promoted by the OpenADR Alliance (www.openadr.org). The Alliance has developed a collection of standards and certifications called Open Automated Demand Response (OpenADR™). These standards describe a Virtual Top Node (VTN) that behaves as a server to issue information related to the demand on the electric utility, including electricity prices; and a Virtual End Node (VEN) that is both a client to the VTN and part of an end-use control system that determines, based on information from the VTN, to what degree, if any, a reduction in energy usage is warranted. The end-use control system reacts accordingly, producing the reductions automatically when that is possible, or by signaling for manually instituted reductions where that is necessary.

One of the areas that can contribute to lowering power consumption, for example in response to a DR event, is the human activity of “watching TV” for which, by a rough estimate, the entire ecosystem consumes about 10% of global energy usage and, by some estimates, roughly half of this amount being attributed to video display devices. Fundamentally, it takes more energy to light up a pixel on a TV set than it does to broadcast the signal that tells the TV set which pixels to light up. This relationship is thought to be reversed for smaller displays such as smartphones, tablets, and laptops that rely on a video streaming infrastructure, but still, a substantial portion of the power directly consumed by the small device is that which drives its display. Thus, the amount of energy consumed by video display devices, in aggregate, is significant, but conventional video display devices have not been integrated into DR systems.

Of course, a video display could be plugged into a circuit that becomes selectably unpowered by an end-use control system based on a DR signal, along with whatever lights, heaters, or other devices were on the same circuit, but that is not a broadly viable solution. In for example the U.S., freedom of speech is a constitutionally guaranteed right, and imposing a requirement to allow a signal that blocks video communication could be subject to legal challenge. Further, many people turn to the TV or other screens for important information, for example regarding the DR event itself, and could thus experience difficulties accessing the information. Additionally, having video displays cut off could inconvenience members of society in other ways. A sports bar that loses its video displays will lose business, too. Children assigned to view an educational programming or citizens attempting to watch or participate in government meetings via local access channels, would be denied those resources if unable to watch them as they are being provided. Accordingly, depowering video displays is not a viable scheme to reduce power consumption upon demand.

As is well known, the power consumption of many kinds of video display is dependent on the brightness in the video image.

For example, in an emissive display having each pixel or subpixel independently controlled, having any pixel reduced in brightness or turned off will reduce the energy used to illuminate that pixel. OLED and micro-LED displays are examples of this kind of display.

In another example, an LCD display can have one or more illumination elements (i.e., backlight modules) each separately controlled and illuminating some subset of the display's pixels or sub-pixels. Typically, the element is driven based on a peak brightness among the pixels or subpixels the zone serves and having that peak brightness reduced allows the element to be correspondingly reduced in brightness, which corresponds to a reduction in the energy used. If the pixels or subpixels served by a zone are entirely black, the zone can even be turned off. Generally, the image savings for LCD displays will be greater for more finely divided backlights, i.e., those having many zones, and somewhat less for more coarsely divided backlights.

In EP 2 112 648 A2, Okan teaches a mechanism for lowering the power consumption for a backlight of an LED display in response to a call for energy reduction. Okan, however does not address emissive displays such as OLEDs, and provides no implementation of the backlight controller and nothing corresponding to modern display elements, such as modular backlights and micro-LED illuminators.

In U.S. Pat. No. 8,803,789 B2, Keller teaches an LED display that, based on a video signal, selects a mode for illuminating the image, or for certain device inputs, only a portion of the screen suitable for banner-formatted content. Keller relies on the content source of the video to select the whole-screen vs. partial-screen mode and does not support emissive displays such as OLEDs.

In “An Active-Matrix OLED Driver CMOS IC With Compensation of Non-Uniform Routing-Line Resistances in Ultra-Thin Panel Bezel” accepted for publication in the IEEE Journal of Solid-State Circuits as of 14 Nov. 2017, Hyun-Sik Kim and Dong-Kyu Kim teach an architecture for an AMOLED source-driver IC, which is representative of at least one kind of matrix display driver of the time, but which will be understood by those skilled in the art as representative of other driver ICs, including those that are pulse-width modulated, or for LCD displays that rely on one or more controlled backlight modules, and for which, as a class, the present principles are an improvement.

The present principles operate in the context of a television set or video display, wherein a video signal is processed to render the video to suit the characteristics of the display matrix, which generally need not match the characteristics described in video standards such as those published by ITU-R as Recommendations BT.709, BT.2020, and BT.2100. Such characteristics include the display's native color primaries, corresponding numeric ranges (e.g., its code-value to optical-output transfer function), and the collective white point for those primaries each at a corresponding maximum code value. This “display-configured video” signal comprises pixel values and clocking information that is provided to a display driver. The primary function of a display driver is to convert the display-configured video into a sequence of analog values, whether voltages and/or currents, and addressing signals to drive the display matrix.

By forcing the data transferred into the sampling latches of the display driver, which then drives the amplitude determining circuits (whether analog or pulse-width modulated), certain pixels of the display-configured video can be blanked. The pattern of blanking can be macroscopic, e.g., blanking a perimeter region of the display such that the display-configured video is presented cropped by a black frame; or sub-scopic (i.e., not discernable from typical viewing distances), e.g., with one or more of alternate columns, rows, or pixels (as in a checkerboard pattern). Some of these blanking patterns can be combined, e.g., a checkerboard blanking pattern with a black frame.

In driver circuits where the display-configured video controls a collection of backlight elements, when the blank frame blanking pattern is selected, one or more backlight elements corresponding to the pixels of the black frame can be provided with code-values that produce analog signals representative of black, thereby producing the blanking.

Activation of the blanking can be as a matter of user preference (in particular if the blanking is sufficiently unobtrusive) or based upon an external signal or policy.

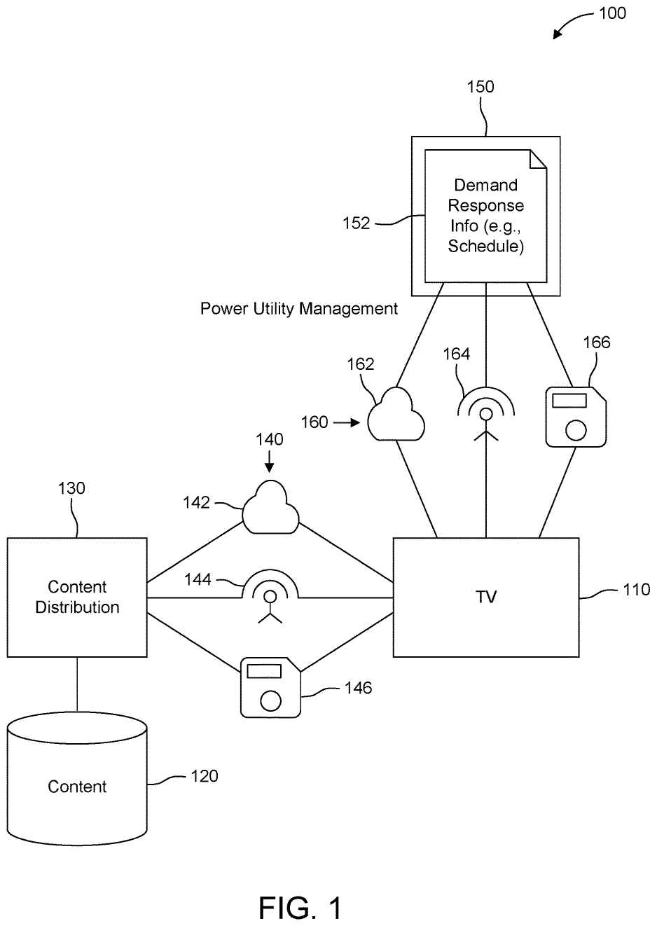

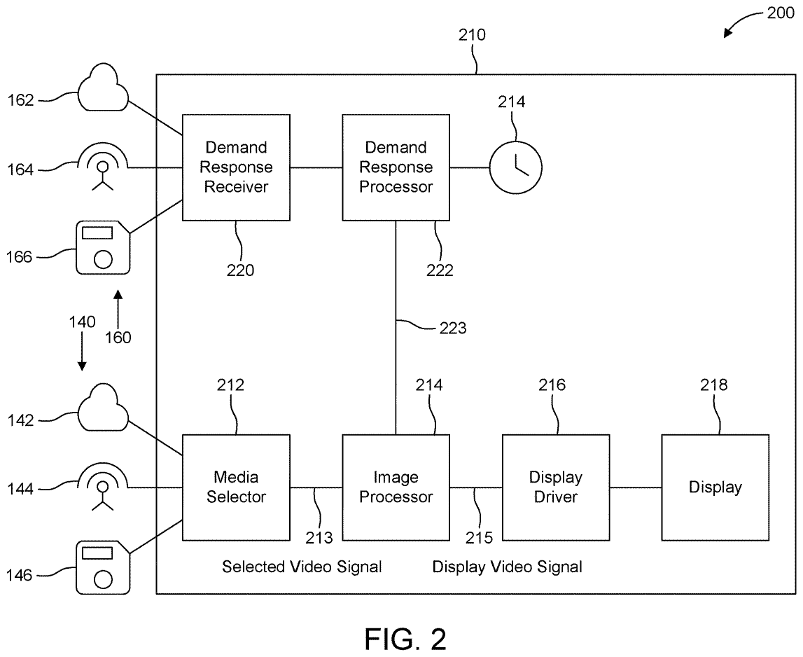

FIG. 1 is a system diagram illustrating an example of a video system 100 according to an embodiment of the present principles. The video system includes an end-user device, exemplified by a TV, 110 according to the present principles, whose operation is discussed in more detail in conjunction with FIG. 2. The TV 110 receives original content 120 through content distribution service 130 as video content delivery 140. Video content delivery 140 can for example include one or more of streaming video 142, terrestrial broadcast video 144, or non-transient media 146, e.g., as a file, Blu-ray disc, digital video disc (DVD), hard drive, memory stick, digital video recorder (DVR), etc.

As is well-known in the art, the original content 120 can be modified using conventional processes for content distribution service 130 to produce the necessary form of video content delivery 140. In some cases, the formatting of the original content 120 is altered, e.g., by cropping and/or changing the aspect ratio of the video image, or by augmenting the video image, e.g., with graphic overlays and/or advertisements. In many cases, the video content 120 is compressed, typically by encoding using a standard codec, for efficient transmission by service 130, in which case video content delivery 140 might be an encoded bitstream requiring decoding by the TV 110 to present the encoded video images. For some forms of content distribution service 130, multiple versions of the content are prepared, e.g., at different resolutions and/or compression to different bitrates (e.g., to supply bitrate ladders), to effectively supply streaming video 142 while adapting to network conditions that could be dynamic and differ among users (not shown, but effectively additional instances of TV 110).

Additionally, TV 110 has communication with power utility management service 150, which provides demand response information 152, of which “demand response (DR) signals” 160 are representative as provided to TV 110. DR signals 160 can be provided via the internet 162, as a wireless transmission 164, as a data file 166, or any other suitable way. In some embodiments, DR signals 160 include a transition and/or current state of a DR condition, e.g., start DR event, DR event in progress, end of DR event, or no DR event in progress. In some embodiments, DR signals 160 include a schedule for when DR events are to occur, e.g., “tomorrow from 4:00 μm to 6:00 μm local time”. In some embodiments, DR signals 160 include pricing for energy, whether current pricing or a schedule of prices, e.g., for the next 24 hours. In some embodiments, DR signals 160 include information describing expected energy supply, expected energy demand, or the margin between the two, whether as a differential energy value or as a percentage. The cases where DR signals include pricing or supply and demand information leave it up to devices, such as TV 110, to determine the conditions during which the device reacts to the DR signals 160 and curtails power use. Whether and to what degree TV 110 exercises curtailment given DR signals 160 can be predetermined as a matter of design, or could be adjusted remotely as a way to update policy, or could be exposed through a user interface as a user setting, allowing the user to establish the current policy under which the device operates.

FIG. 2 illustrates a block diagram 200 for one example embodiment an end-user device 210 according to the present principles, such as the end-user device 110 in FIG. 1. In the non-limitative example, the end-user device is a TV in which conventional media selector 212 is configured to switch among a plurality of video sources and deliver a selected input video signal 213 to image processor 214. Image processor 214 accepts selected video signal 213 and transforms it to produce a display-configured video signal 215 for use by display driver 216. Display driver 216 produces the correct set of voltages, currents, clocks, and signals necessary for display 218 to present the video images represented by display video signal 215.

By way of example, media selector 212 can include a High-Definition Media Interface (HDMI) input port that can accept video from a disc (e.g., DVD or Blu-ray disc) files as non-transient media 146. Likewise, media selector 212 can include a USB port that can accept a memory device containing non-transient media 146 media files. Media selector 212 can include a tuner, for example one configured to receive ATSC 1.0 and/or ATSC 3.0 signals, to be tuned to an appropriate television station and to extract an appropriate program such as terrestrial broadcast 144. Media selector 212 can include a network interface, whether wired or wireless, and one or more applications providing access to streaming content through a network to access media such as streaming video 142. In the unusual case where end-user device 210 has only one video input interface (e.g., a single HDMI port), then media selector 212 is optional and selected video signal 213 could come directly from the sole video input.

Image processor 214 is configured to prepare the selected video 213, in consideration of at least the characteristics of the selected video signal 213 and display 218, and deliver the resulting display-configured video 215 to display driver 216.

In a conventional TV, an image processor is configured to transform a video signal from a standardized video interchange representation (e.g., based on signal standards ITU-R Rec BT.709 or ITU-R Rec BT.2020) to an internal video representation suitable for use by the TV's display driver. There are multiple kinds of transformations that are handled by the image processor.

In some cases, the image processor 214 adapts the resolution of the selected video to the native resolution of the display so that the display driver can operate on a strictly one-to-one basis. Consider for example, a native resolution of the display being 1280×720. An image processor might accept video signals at any of several resolutions (e.g., 640×480, 1280×720, 1920×1080). To adapt these resolutions to the native resolution of this display, the image processor might transform the resolution of the incoming video signal with an upward scaling (e.g., for 640×480) or downward scaling (e.g., for 1920×1080), or leave the resolution unchanged with a unity scaling (for 1280×720). Cropping, pillar-boxing, or letter-boxing might also be a part of resolution transforms, e.g., where a video image having a first aspect ratio is mapped into display having a different aspect ratio, that either results in filling the screen top to bottom but losing the some of the right and left edges of the image (cropping), or retaining the original aspect ratio by filling the screen from side-to-side but not filling the screen from top to bottom resulting in black bars above and below the image (letter-boxing).

In the example of a 640×480 incoming video signal being upscaled to map into a 1280×720 display, a scale factor of 2 will fill the screen side-to-side with the image (640×2=1280), but the top and bottom of the image will be cropped (480×2=960, greater than the display height of 720); alternatively, a scale factor of 3/2 will fill the screen top-to-bottom with the image (480×3/2=720), but the image won't fill the screen horizontally (640×3/2=960, less than the display width of 1280), so to either side of the image, a black bar is placed, i.e., pillar-boxing (each (1280−960)/2=160 pixels wide).

In some cases, an image processor adapts a video signal from a color difference format to a red, green, blue (RGB) additive color format. Color difference representations are a class of color space where the signal representing brightness is isolated from signals representing opposition colors red-green and yellow-blue. This can allow for a more efficient, compact representation of color images that is also well-suited to further compression, but that is transformed into an RGB format for delivery to the display driver for presentation on the display. The image processor is configured to perform the appropriate transform the video color values to the form needed by the display and expected by the display driver.

Further, the color primaries produced by the display and the physical electro-optical transfer functions of each of those primaries (i.e., what voltages, currents, or code values produce how much light), are as much a matter of design choice as is the native resolution: All are determined by physical aspects of the display that are set at the time the display is manufactured.

The image processor might accept video signals having any of several, typically standardized, color encodings and/or transfer functions (e.g., electro-optical transfer functions), while the display driver will operate with a single, particular color encoding and a single, particular transfer function, which are typically proprietary and largely determined by the display. All of which affects the transforms which the image processor is required to provide.

According to the present principles, the image processor 214 can behave in the conventional manner, providing the display driver 216 with a display-configured video signal 215.

DR receiver 220 is configured to receive DR signals 160 from at least one source. In some embodiments, DR receiver 220 includes a connection to the internet and is configured to retrieve or accept DR signals 162 from a remote server (e.g., one provided by the power utility management 150 in FIG. 1). In some embodiments, DR receiver 220 might include a wireless receiver, e.g., for Wi-Fi, terrestrial television broadcast, paging, Bluetooth™, or cellular services, and is configured to receive information 164 by wireless communication. In some configurations, DR receiver 220 includes a file-based interface and is configured to access DR signals file 166 at least occasionally, to keep abreast of updates. In some configurations, the DR receiver 220 includes an implementation of a virtual end node (VEN) in accordance with OpenADR as specified in the publicly available specification (PAS) published by the International Electrotechnical Commission (IEC) as IEC/PAS 62746-10-1, or similar protocols, to receive information 160 as the signals described therein from grid and/or market operators (such as power utility management 150 in FIG. 1) for managing customer energy resources, particularly load.

DR signals 160 received by DR receiver 220 are communicated to DR processor 222, which determines the current DR status, and provides DR event signal 223 to the display driver 216, which indicates whether a DR event is in progress. In some embodiments, DR event signal 223 can indicate a degree (e.g., graduations of severity) of a DR event in progress.

In some embodiments within which DR signals include a schedule, DR processor 222 employs a local time of day clock 222 or a remote time service (not shown) to determine the current status based on the schedule.

In some embodiments, where DR signals 160 include energy pricing information, DR processor 222 determines a lower threshold price, above which the DR event signal 223 is active. In some such embodiments, the DR processor 222 may determine severity of the event. For example, the DR processor may further determine a second upper threshold price, above which a DR event is most severe, wherein the degree indicated by the DR event signal 223 is based on the current status energy pricing and the two thresholds: No DR event when the current price is below the lower threshold, a most severe DR event when the current price is at or above the upper threshold price, and a DR event of a proportionally lesser severity when the current price is between the lower and upper threshold prices. This may for example be computed by EQ. 1 in which the current price is indicated by price, the lower threshold by thresholdₗ and the upper threshold by thresholdᵤ:

$$severity ( price ) = \{ \begin{matrix}0 : & price < {threshold}_{l} \\ 1 : & price \geq {threshold}_{u} \\ \frac{( price - {threshold}_{l} ) q}{( {threshold}_{u} - {threshold}_{l} )} : & otherwise\end{matrix} \} \qquad EQ . 1$$

In some embodiments, where DR signals 160 include information about the amount of energy available and energy demanded, or about the margin therebetween, DR processor 222 can determine a first warning threshold margin, below which the DR event signal 223 is active. In some such embodiments, the DR processor 222 may determine severity of the event. For example, the DR processor may further determine a second critical threshold margin, below which a DR event is most severe, wherein the degree indicated by the DR event signal 223 is based on the current status energy availability and energy demanded, or the margin there between, and the two thresholds: No DR event when the current margin is greater than warning threshold margin, threshold_{w}, a most severe DR event when the current margin is lower than the critical threshold, threshold_{c}, margin, and a DR event of a proportionally increased severity when the current margin, margin, is between the warning and critical threshold margins, for example as computed by EQS. 2 and 3:

$$margin = \frac{{energy\_available}_{current} - {energy\_demanded}_{current}}{{energy\_available}_{current}} \qquad EQ . 2$$

$$severity ( margin ) = \{ \begin{matrix}0 : & margin > {threshold}_{w} \\ 1 : & margin \leq {threshold}_{c} \\ \frac{( {threshold}_{w} - margin )}{( {threshold}_{w} - {threshold}_{c} )} : & otherwise\end{matrix} \} \qquad EQ . 3$$

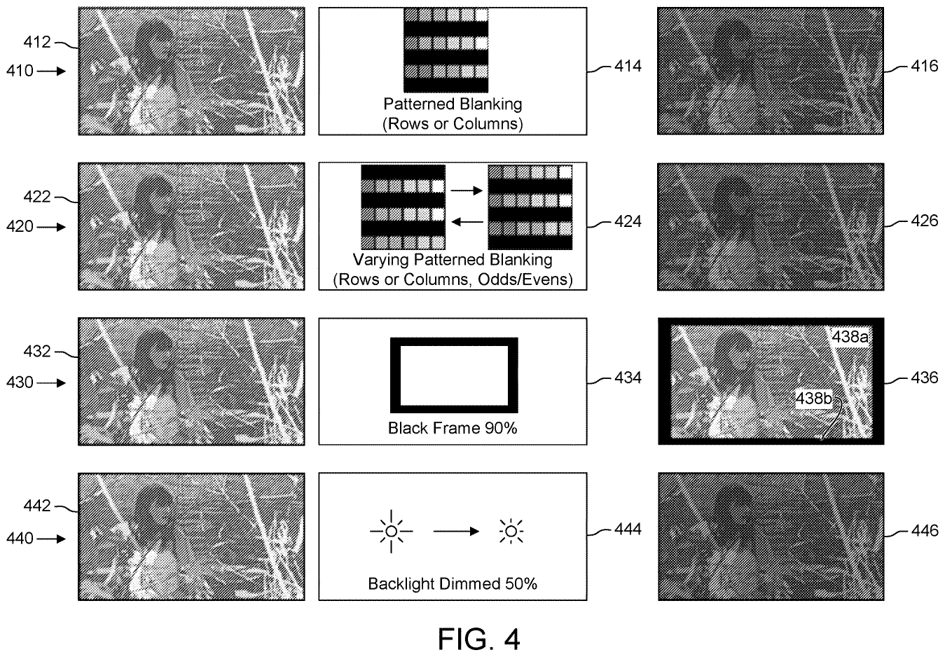

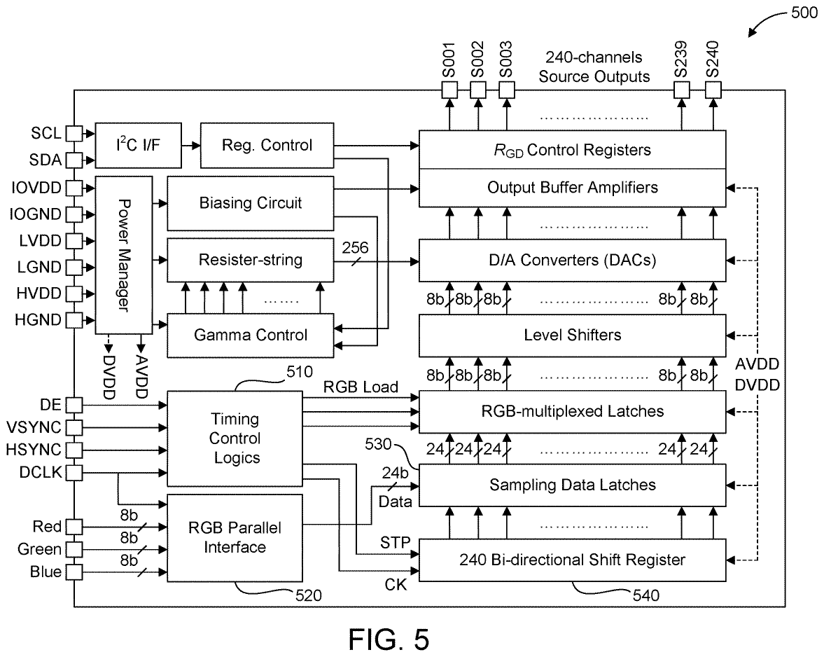

In reaction to DR event signal 223 indicating that a DR event is not in progress, image processor 216 can perform in the conventional way, such as those described above and further in conjunction with FIG. 5, which is representative of the prior art. However, the display driver 214 reacts differently to a DR event signal 223 indicating that a DR event is in progress by causing various regions of the display to be blanked. These different reactions are discussed in more detail in conjunction with FIG. 4.

Note that the equations EQ. 1 for severity(price_{current}) and EQ. 3 for severity(margin_{current}) are clamped to the closed range [0,1] and strictly linear within the range, however other equations that are merely monotonic, rather than strictly linear, can be used. Some embodiments may determine severity in a non-linear way, thus reaching higher degrees of severity (i.e., approaching 1) earlier in the function (e.g., at a lower price, or while the margin is greater). Also note that, whether or not the determination of severity is linear in comparison to price or margin is independent of how display driver 216 reacts to event signal 223, and how that reaction affects power consumption of the system-a non-linear computation of severity might be unnecessary if the energy savings resulting from the reaction of image processor 214 already fulfil the desired relationship. The computation of severity and the reaction of image processor 214, can be examined collectively to determine whether the collection response represents the design intent.

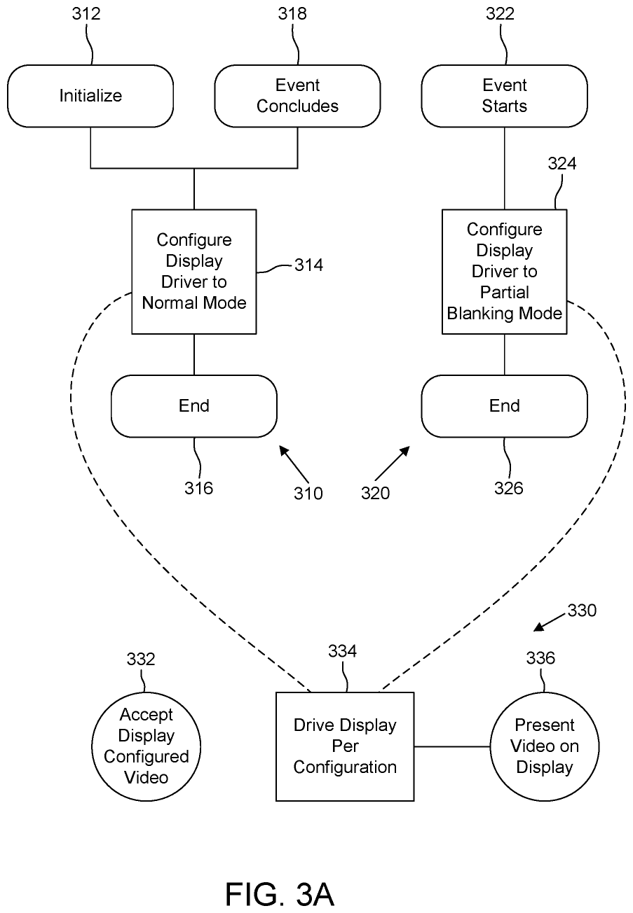

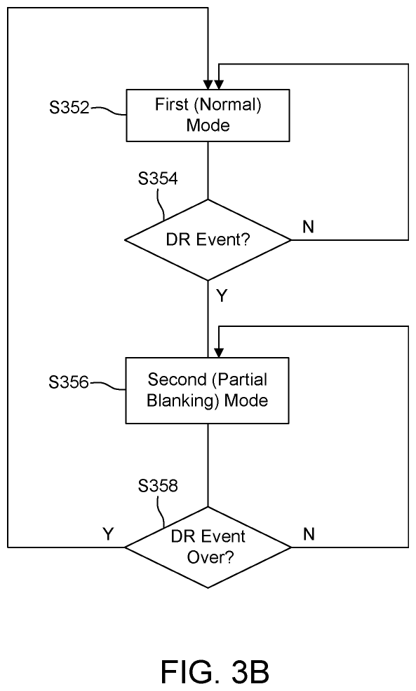

Turning to FIG. 3A, three processes 310, 320, and 330 are shown as flow charts. Upon initialization 312, a DR processor (e.g., 222 of FIG. 2) performs initialization process 310 and configures display driving step 334 to a normal mode at 314. Communication of this normal mode configuration from step 314 to display driving step 334 is illustrated as the dotted line running between 314 and 334. Display driver 216 in FIG. 2 is suitable for performing display driving step 334, in which case normal mode corresponds to conventional operation of the display driver in a television, where all of the display-configured video signal 215 is presented on video display 218. The initialization process 310 concludes at 316.

DR process 320 begins when a DR event is detected by a DR processor (e.g., 222 of FIG. 2). DR process 320 configures display driving step 334 to a reduced-energy mode at configuration step 324. Communication of this reduced-energy configuration from step 324 to display driving step 334 is illustrated as the dotted line running between 324 and 334. DR process 320 ends at 326.

Note that the exit of process 320 at 326 does not represent the end of the DR event, nor a device's response to a DR event that has occurred. Rather, when the DR processor (e.g., 222) detects that the DR event has ended or that there is no DR event, then initialization process is initiated at 318, and otherwise operates as described above.

While operating, a display driver of the present principles (e.g., 216 in FIG. 2) performs display drive process 330 which comprises accepting 332 an input display-configured video signal, such as from image processor 214. In display driving step 334, the input video is transferred to the display in accordance with the current mode, either as-is, if the normal mode is set at 314, or in a reduced-energy mode as set at 324. The display-configured video is sent at 334 by display driver (e.g., 216 in FIG. 2), with or without any blanking in accordance with the currently set configuration, to a display (e.g., 218 in FIG. 2).

Also, in response to a DR event, DR processor 222 or configuration step 324 can detect varying degrees of severity and select one or more reduced-energy modes blanking accordingly, as discussed below in conjunction with FIG. 4.

FIG. 3B illustrates the flowcharts of FIG. 3A in a different way. In step S352, an end-user device performs in the first, normal mode (i.e., without particular power saving). In step S354, it is determined whether a DR event is ongoing. In case it is not, the method returns to step S352; in case it is, the method continues in step S356 in which the end-user device performs in the second, partial blanking mode (i.e., with a goal of saving energy). In step S358, it is determined if the DR event is over. In case it is not, the method returns to step S356; in case it is, the method returns to step S356 and the first mode.

In some embodiments, rather than having only two configurations (normal mode as set at 314 and reduced-energy mode as set at 324), display driving 334 may be responsive to a finer division of the continuum between those two modes. For example, the change in behavior at step 334, from a normal mode to a reduced-energy mode, following execution of DR process 320, might not be an instantaneous change, not affecting one frame at all but modifying the next frame in the full degree. Instead, such embodiments may gradually transition between the modes, for example taking up to 15 minutes before video frames are fully affected by the reduced-energy mode. Ideally, the transitions between normal and reduced-energy modes go unnoticed by a viewer watching the display. Implementations of such gradual transitions can be achieved by temporal filtering of one or more of the parameters set by the normal and reduced-energy modes.

In an alternative embodiment, a combined initialization and DR response process (not shown) performs temporal filtering to determine a current effective mode, based on the temporal filtering and/or severity indicated by DR event information and determined by DR processor (e.g., 222 in FIG. 2).

FIG. 4 shows a variety of examples (410, 420, 430, 440) of display driving modes that can be performed by a display driver according to the present principles (e.g., 216 in FIG. 2) while configured in a reduced-energy mode, e.g., following the performance of step 324 in FIG. 3. In these examples, while input images 412, 422, 432, 442 are shown at the same size and aspect ratio as resulting images 416, 426, 436, 446, respectively, this does not imply that the input images and the output images need be at the same resolution and/or aspect ratio, though they can be. As discussed above, the resolution of the overall image represented by display-configured video signal 215 output by the image processor 214 is going to be appropriate to the display characteristics. In the case of the embodiment illustrated in FIG. 2, this is determined by the resolution of display 218 and the corresponding resolution of the input of display driver 216. In cases where the input image is supplied at a resolution different than that of the output image, that different resolution is covered, but not illustrated by FIG. 4. Likewise, for cases where the input image is supplied at an aspect ratio different than that of the output image, that different aspect ratio is covered, but not illustrated by FIG. 4.

Row 410 shows a first example embodiment of display driving step 334 in which display-configured video image 412 from an image processor (e.g., display-configured video signal 215 from image processor 214) undergoes blanking 414 of alternate rows (e.g., blanking of even rows) in the resulting presentation 416 on the display, where output image 416 appears dimmer than conventional display of video 412 because alternate rows of the display are blanked. Blanking alternate rows of the display in a direct emission display (e.g., OLED or micro-LED) would reduce the expected energy draw by the fraction of pixels being blanked, i.e., 50%. In an alternative embodiment, blanking can be applied to alternate columns.

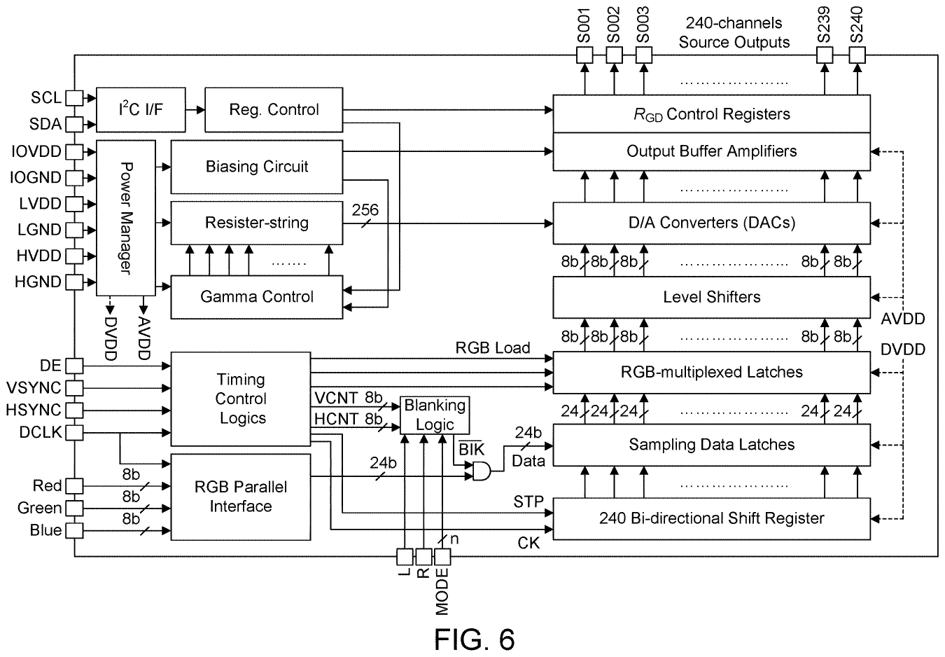

Row 420 shows a second example embodiment of display driving step 334 in which display-configured video image 422 from an image processor (e.g., display-configured video signal 215 from image processor 214) undergoes blanking of alternate rows 424, wherein the alternate rows are occasionally varied (e.g., blanking of the even rows for some number of frames, followed by blanking of odd rows for some number of frames) in the resulting presentation 426 on the display, where output image 426 appears dimmer than convention display of video 422 because alternate rows of the display are blanked. The occasional switching, which may be periodic, can be useful to minimize the appearance of burn-in caused by prolonged use of a reduced-energy mode. The occasional switching should be infrequent, e.g., every 8 minutes or so, to ensure that the switching, even if barely noticeable, is at least not so frequent as to become annoying. The 8-minute figure roughly corresponds to 16,384 frames of video at 30 fps, wherein control of the switch between odd and even rows being blanked could be implemented by the most-significant bit of a 15-bit frame counter (as further discussed in conjunction with FIG. 6). In an alternative embodiment, blanking can be applied to alternate columns, switching between blanking the odd and even columns.

Row 430 shows a third example embodiment of display driving step 334 in which display-configured video image 432 from an image processor (e.g., display-configured video signal 215 from image processor 214) undergoes a perimeter-region blanking 434, resulting in example presentation 436 in which black frame 438b clips the image 438a. Blanking the perimeter portions of the display in a direct emission display (e.g., OLED or micro-LED) would reduce the expected energy draw by the fraction of pixels being blanked, in this example case, 10%. In some embodiments, where an LCD spatial light modulator-based display has a modular backlight, backlight elements in the perimeter region dim in response to the pixels corresponding to the perimeter region having been blanked, just as they would response to the corresponding pixels having been black in the selected video.

Row 440 shows a fourth example embodiment of display driving step 334 in which display-configured video image 442 from an image processor (e.g., display-configured video signal 215 from image processor 214) undergoes a reduction in luminance by dimming the backlight 444, resulting in output image 446 in which the reduced luminance corresponds to a similar reduction in energy consumption by the display.

FIG. 5 presents a representative display driver of the prior art. Circuit architecture 500 is for the display driver chip of Kim and Kim (disclosed above). Pertinent well-understood elements include the timing control logics 510 that accepts as input a device enable (DE), vertical sync (VSYNC), horizontal sync (HSYNC), and a data clock (DCLK) and produces a trio of mutually exclusive signals (RGB Load) for loading red, green, and blue data in color-multiplexed latches, and a step direction STP and clock signal CK to bi-directional shift register 540. RGB Parallel Interface 520 accepts 8-bit data for red, green and blue values (Red, Green, Blue) of each current pixel, the capture of which is triggered by DCLK. The resulting 24-bits of data (Data) is captured in one of 240 sampling data latches 530, collectively, as selected by the state of the shift register 540. From there, the RGB Load signals multiplex the red, green, and blue values, 240 samples wide, into the level shifters, to the digital-to-analog converters, and to the output buffer amplifiers to drive 240 columns of pixels, each with an RGB component, in the display matrix. This particular circuit is directed to an OLED display and provides the source signal for each column, though the principles apply generally to other matrix display technologies. Since this circuit supports only 240-pixel columns, multiple driver chips are used to address displays wider than 240 pixels. For example, a 1920 pixel-wide high-definition screen would require eight chips.

FIG. 6 presents a driver chip architecture 600 according to the present principles, which is presented in the context of the prior art chip architecture 500 of FIG. 5, as an enhancement to that architecture, to demonstrate how the present principles integrate into a display driver.

Timing and Control logics 610 act as does logics 510, though with the addition of two extra outputs, the horizontal count 652 (HCNT) and vertical count 654 (VCNT), which could already be available within logic 510 and merely exposed in this configuration. However, if not, HCNT and VCNT can be produced by two counters (not shown): a horizontal pixel counter that increments with each count of DCLK and resets with each HSYNC pulse, and a vertical pixel counter that increments with each HSYNC pulse and resets with each VSYNC pulse. In some embodiments discussed below, a frame counter (not shown) increments with each VSYNC pulse and need not be reset, being allowed instead to roll over.

In this embodiment, the elements RGB Parallel Interface 620, Sampling Data Latches 630, and 240 Bi-directional Shift Register 640 perform conventionally as do their counterparts 520, 530, and 540, however the 24-bit output signal 622 from Interface 620 is interrupted by a 24-bit by 1-bit AND-gate 672, rather than running directly from interface 520 to latches 530 as in FIG. 5. The function of AND-gate 672 is to selectively blank, that is to say, to zero, the RGB pixel data provided by the interface 620 before being captured by latches 630. The control of this blanking is the NOT-BLANK line 670, which presents a logic zero when blanking is to take place and a logic one when no blanking is imposed. The construction of 24-bit by 1-bit AND-gate 672 is logically 24 conventional, two-input AND-gates, where one input of each of the gates is tied to NOT-BLANK line 670, and the other to a corresponding one of the bits from interface 622. Conventional two-input AND-gates can be built using four CMOS transistors, thus 96 transistors for 24 such gates. However, for some embodiments of AND-gate 672, a savings of 23 transistors (almost 25%) is available by using a single transistor driven by NOT-BLANK 670 for the series pull-up for all 24 AND-gates, instead of 24 distinct transistors. The resulting 24-bit result 674 (Data in FIG. 6) is provided to latches 630 and is otherwise sampled similarly based on the state and transitions of shift register 640.

Blanking Logic module 650 accepts HCNT the horizontal count 652 and VCNT, the vertical count 654, along with three external signals leftmost (L) 662, rightmost (R) 664, and Mode 668, of which only the mode signal 668 is required.

Mode signal 668 comprises n-bits, where n is at least one, to signal normal mode vs. reduced-energy mode. If there are multiple reduced-energy modes available, then mode signal 668 provides more bits, whether in parallel or serially. When the number of energy-reducing modes=m, if the number of bits n=m (as shown in FIG. 6), then each energy-reduction mode has a separate parallel signal, and normal mode corresponds to none of the reduced-energy modes being signaled on that fully parallel interface. Alternatively, communication of which mode or modes should be active could be via a serial protocol but could involve a single-bit protocol, known in the art, or other conventional address and data schemes, to communicate a multi-bit value over a different signal channel instead, regardless, the logical values are the same. Whether mode 668 is implemented as a parallel interface or with a serial protocol, the speed at which mode 668 must update is modest, being not usefully faster than once per frame, and more typically, not more than once every several seconds). Thus, mode signal 668 represents a light demand for the driving processor, and could accept DR event signal 223 from demand response processor 222 directly.

Internally, blanking logic 650 can comprise a number of evaluation modules, that logically evaluate for each of the available reduced-power modes, a corresponding blanking signal. When a particular reduced-power mode is active, (e.g., the corresponding bit in a parallel implementation of mode input 668 is true) and the corresponding evaluation module finds that blanking is appropriate, then a two-input AND-gate (not shown) combines the mode bit and evaluation module output into a mode output. This occurs simultaneously for all of the reduced-power modes with the resulting mode outputs being combined in an n-input NOR-gate to create.

Thus, if any active mode considers blanking to be appropriate, that signal as a true input to the nor gate drives the output of the NOR-gate to false, thus signaling blanking with the NOT-BLANKING signal 670, but only for the pixels for which blanking appropriate. In normal mode, where no reduced-power mode is active and thus no input to the NOR-gate is calling for blanking, the output of the NOR-gate is true, and no blanking takes place for any pixel.

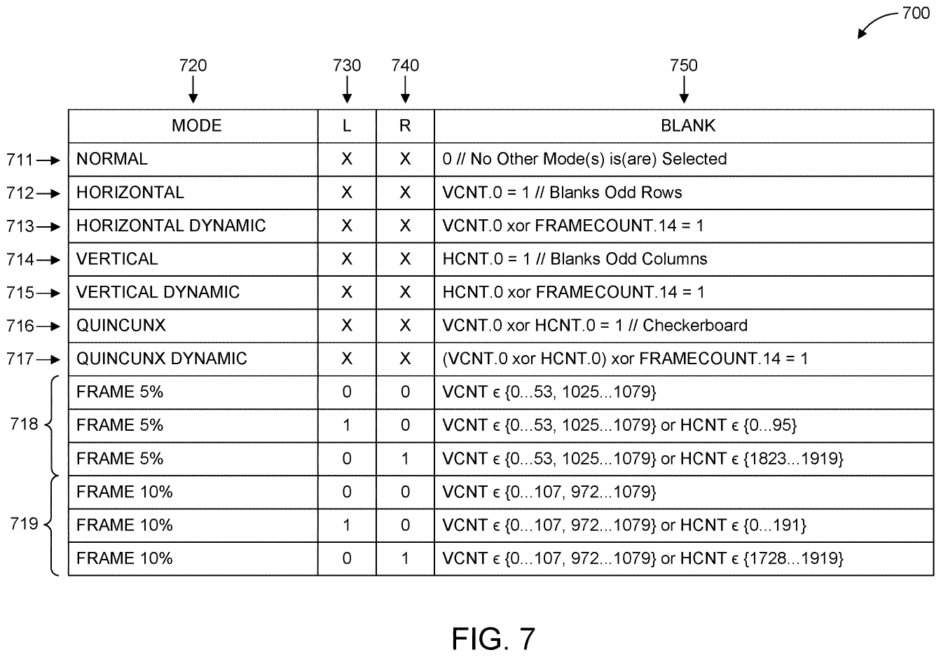

FIG. 7 provides a table 700 showing a number of example reduced-power modes 712-719 of the present principles and the corresponding evaluations 750 to determine blanking induced by each mode.

Entry 711 in the table represents normal mode, which represents when no reduced-power modes are active, however normal mode needn't have any special implementation and does not require an input to the NOR-gate logic described above. It is sufficient that no other mode is calling for blanking that the effective result is that no blanking is called for, as symbolized by the evaluation 750 of the constant “0”, i.e., always no blanking.

Entries 712 and 714 represent modes where odd-numbered rows or odd-numbered columns are blanked, respectively. The evaluation 750 is based on the least-significant bit of the vertical count 654 (VCNT.0) or horizontal count 652 (HCNT.0) respectively. If the least significant bit is a 1, the row/column is odd, and thus represents a call by the evaluator for blanking.

A disadvantage of a fixed blanking like entries 712 and 714 is that odd rows/columns, by virtual of blanking, are less used. If there is a concern that this could lead to a noticeable difference in appearance (e.g., if a particular variety of OLED dims with cumulative usage), then modes 713 and 715 provide similar operation to 712 and 714 respectively, but with a periodic alternation between blanking odd rows/columns and blanking evens, thus leading to essentially equal aging-by-use of the sub-pixel elements, at least the blanking does not contribute to differential use. This is achieved by an exclusive- or (XOR) operator being applied to the least significant bit (either VCNT.0 or HCNT.0) and a higher order bit in the frame count value discussed above, e.g., FRAMECOUNT.14, which would change every 32,768 frames, which at 30 frames per second is about every 18.2 minutes, thereby reversing the blanking from odd to even and back in an unobtrusive manner. Other schemes could be implemented in lieu of frame count, for instance, a detector (not shown) for an all-black screen, which commonly appears in movies between scenes, or in broadcast video between commercials, the detection toggling a D-type flip-flop (not shown) used to track whether it is the odds or evens being blanked, thus toggling each time the display-configured video signal goes black.

Entries 716 and 717 relate to a checkerboard pattern, where every other pixel vertically and horizontally is blanked. The basic checkerboard pattern is obtained by a two-input XOR-gate operating on the least significant bits of both VCNT.0 and HCNT.0, which is how the evaluator 750 for 716 operates. 717 addresses the concern of uneven aging above, by a further XOR operation, e.g., with FRAMECOUNT.14 or black-image tracking flip-flop, or similar mechanism to ensure the transitions are unobtrusive.

The skilled person will have noted that none of the evaluators 712-717 have used the L in column 730 signaling leftmost input 662 or the R in column 740 signaling rightmost input 664. Accordingly, for these rows, columns 730 and 740 are marked X for “don't care”. This changes for the three entries for each of reduced-energy modes 718 and 719 occur because these evaluators depend on the inputs leftmost 662 (L) and rightmost 664 (R) to blank regions along the left and right edges of the display.

For displays wider than can be accommodated with a single chip 600, which for the embodiment shown would be displays more than 240 pixels wide, these evaluators need information that indicates the position of the chip in the array. In this example, considering a typical High Definition (HD) display of 1920 pixels wide, it would take 8 column driver chips 600, addressing 240 rows each, from left to right. Evaluators 718 and 719 both need to understand whether the chip on which they reside occupies a position at the left or right edge, so that comparisons of the current pixel position, as represented by VCNT 654 and HCNT 652, can be compared to the perimeter regions. For example, for a blanking frame whose thickness is 5% of the corresponding screen dimension (height or width), the first of the three rows for evaluator 718 blanks is used by chips for which neither of the inputs leftmost 662 nor rightmost 664 is true, as this evaluator only addresses the top and bottom edges, where the 54 rows in the range [0 . . . 53] represent the first 5% of the rows in a display matrix that is 1080 rows tall, while the 54 rows in the range [1025 . . . 1079] represent the last 5% of the rows. At all other times, no blanking takes place from this entry. The second of the three rows for evaluator 718 is used by chips for which the leftmost input 662 is true, as these address not only the top and bottom edges (as above) and the left edge, too, where HCNT is in the range [0, 95], representing the first 96 columns of the display matrix. Likewise, the third row is used by chips having the rightmost input 664 true, signaling that it is to address the top and bottom edges (as above), and the right edge, too, where HCNT is in the range [1823-1919]. The three entries for evaluator 719 are similar, with the values in the ranges representing a border that is 10% of the image height at the top and bottom, and 10% of the image width at the left and right.

Those skilled in the art will recognize that a 10% border along the left and right edges, being 192 pixels for an HD display of 1920 columns, is withing the extent of a single driver chip addressing 240 columns. However, for higher resolution displays, such as those in the Ultra High Definition formats such as 4K (3840 columns) or 8K (7680 columns) display, a 10% border could exceed the span of a single display driver chip, in which case the L and R inputs would require more bits to signal, for example, the first, second, third, fourth chip from the left, or first, second, third, fourth chip from the right. For a particular frame width, it could be that the first chip and perhaps the second or third are fully within the border and blanks when that frame width mode is selected. The next chips inward would specify a range, where some columns for that chip would blank when in the mode, others might not, depending on the current row. Chips entirely interior to the left and right edges of the frame react only to the top and bottom edges, as above. Accordingly, this scheme can enable such display driver chips to be used on displays of high dimensions, or for reduced-energy modes that blank frames that are thicker than 5% or 10%.

Those skilled in the art will recognize that optimizations may be made in the evaluator expressions 750. For example, the expression “VCNT E {0 . . . 53, 1025 . . . 1079}” from the first row of the FRAME 5% evaluator discerns whether the current row is within either the top or bottom edge region need only be evaluated once, and not separately for each of the three rows. In another example, the ranges being given for determining proximity to an image edge, rather than being fixed values in the logic of the evaluators, could be dynamic, being externally set. In still another example, rather than implementing “VCNT is a member of a first range and a second range, different expressions that have the same results ca be used, e.g., (VCNT<54) or (VCNT>1024), where such implementations might be easier.

Where progressing onset or release of an energy-saving mode such as FRAME 10%, is desired, the range values are dynamic, once the mode is engaged, perhaps incrementing to a limit, or decrementing, with each transition of FRAMECOUNT.8 or about every 17 seconds at 30 frames per second, so that the onset of a border frame takes place over 15 minutes or so.

A similar timing can be applied for changes in the backlight. Of course, mechanisms for timing can be used to graduate the onset or retreat of such energy-saving modes.

Greater energy-reductions can be achieved with multiple modes being active simultaneously. For example, the HORIZONTAL energy-reducing mode 712 saves 50% by blanking half the pixels and the VERTICAL mode 714 does likewise. When active together, the net savings is 75% as the only pixels remaining are the 25% that are at the intersections of odd columns and odd rows. Still further, FRAME 10% mode 719 could be added, to get another 2.5% savings (since the border region has already been reduced so only 25% of pixels remain active, it's only those 25% that could contribute to further savings, and only 10% of those are in the border region).

Some care should be exercised for modes used together: for example, combining HORIZONTAL 712 with HORIZONAL DYNAMIC 713 isn't valuable. Half the time, the second mode does nothing, because both modes blank the odd rows, the other half of the time, the entire image is black, because one evaluator blanks odd rows and the other blanks even rows, and no pixels remain unblanked.

For an ideal display, i.e., one which consumes energy exactly equal to the radiometric flux of the photons forming the displayed image, the expected percentage energy savings due to blanking is exactly the portion of pixels set to black. This fractional energy savings holds even for the portion representing a linearly lossy display, i.e., one which consumes energy exactly proportional to the radiometric flux of the photons forming the displayed image (where the proportion is >1.0). If there are non-proportional portions of a display's energy consumption, these will alter this relationship. For example, if a portion of a television's power consumption is independent of the video, but the remainder is proportional to light being produced, then the fractional energy savings is modeled by EQ. 4 below, in which energy_{Luminance} is the amount of energy consumed to display an image having a mean luminance of L in normal mode, i.e., before any blanking is applied. EQ. 4 assumes that the luminance of the image is, statistically speaking, evenly distributed spatially, when considering all the images of a hypothetical video, and not statistically clustered in the manner of blanking (e.g., not clustered in even rows, not clustered at or away from the perimeter). When energy_{constant} is small relative to energy_{Luminance}, then fractional_energy_savingsₙₑₜ approaches fractional_energy_savings_{blanking_fraction}.

$$fractional\_energy {\_savings}_{net} = \frac{( \begin{matrix}{energy}_{constant} + {energy}_{L} \times \\ fractional\_energy {\_savings}_{blanking \_ fraction}\end{matrix} )}{( {energy}_{constant} + {energy}_{Luminance} )} \qquad EQ . 4$$

If there is a portion of the energy consumed that corresponds to non-linear energy losses (e.g., a hypothetical power supply whose efficiency varies with power draw, or varies by historic power usage and/or environmental factors due to cumulative heating), then a mathematical model of fractional energy savings will depend on the specific physics involved.

It is not required that display driver 216 operate bimodally, i.e., normal mode and a single reduced-power mode. In some embodiments, the value of DR event signal 223 may report a temporally smoothed transition, rather than the one-of-two discrete states of a DR event is not in progress (e.g., 0) or a DR event is in progress (e.g., 1). For example, the transition between the two discrete states could be smoothed by use of a temporal filter or ramping function. In such embodiments, the smoothed signal might be treated in the same way as described for severity, in the closed range of [0, 1], where zero represents “a DR event is not in progress” and a non-zero value represents “a DR event is, or recently was, in progress.” Smoothing can also be applied to otherwise discontinuous changes in severity.

The advantage of smoothing the DR event signal 223 is two-fold: first, a viewer of the display 218 will not observe a sudden radical change to the image displayed. Ideally, the transition to the reduced, partial blanking, mode is made slowly enough to escape noticed. Second, the power grid will not experience a sudden change in load, rather the onset of reduced mode or the return to normal mode is spread out over many minutes.

Fixed-rate smoothing can be achieved by applying a periodic, fixed-magnitude signal change δ to the current value of DR_event signal_{smoothed} until the value of DR_event_signal 223, determined by demand response processor 222, is reached. One example embodiment of such a smoothing function is presented in EQ. 5, which updates DR_event signal_{smoothed} at each uniform time increment Δt.

$$DR\_event {\_signal}_{difference} ( t ) = DR\_event \_signal ( t ) - DR\_event {\_signal}_{s moothed} ( t ) \qquad EQ . 5$$

$$DR\_event {\_signal}_{s moothed} ( t + Δ t ) = DR\_event {\_signal}_{s moothed} ( t ) + \{ \begin{matrix}0 : & DR\_event {\_signal}_{difference} ( t ) = 0 \\ \begin{matrix}Minimum \\ ( δ , DR\_event {\_signal}_{difference} ) :\end{matrix} & DR\_event {\_signal}_{difference} ( t ) > 0 \\ \begin{matrix}Maximum \\ ( - δ , DR\_event {\_signal}_{difference} ) :\end{matrix} & DR\_event {\_signal}_{difference} ( t ) < 0\end{matrix} \}$$

The fixed-magnitude signal change δ and time increment Δt should be chosen such that the difference in the presentation on display 218 from display driver 216 of display-configured video signal 215 when DR_event_signal_{smoothed} changes by δ is unnoticeable, even when applied at intervals of Δt. By way of example, Δt is 1/30 of a second and the selected video signal 213 has a frame rate of 30 frames per second. The smoothed DR event signal will approach the appropriate value by, at most, δ per frame. If δ is chosen so that image processor 214 changes its image size reduction for reduced-power mode behavior by at most 2 pixels (one at each of the left and right edges) then a reduction to 81% of normal-mode power by blanking the perimeter region to a thickness that is 5% of image width at the sides and 5% of the image height at the top and bottom (e.g., blank pixels around the perimeter such that the remaining unblanked image is 90% of the original width and 90% of the original height, i.e., 81% of the pixels from the display-configured video 215 remain unblanked). An image having a full-screen width of 1920 would take (1920 pixels×10%)/2 pixels per reduction×(1/30) seconds=3.2 seconds for the onset of reduced-energy mode to complete, which perhaps is quick enough to be noticeable. If Δt were increased to five seconds, then the same transition would take 480 seconds, or eight minutes, which would be slow enough to remain unnoticed, yet fast enough to be useful for power utility management 150.

Finally, in some embodiments, the present principles accept input via user interface (not shown) to select a power derating setting. This setting allows a user to express a preference for a display to save energy. Such a preference can be asserted in either of two ways: first, the user preference can modify the DR event signal value issued when a DR event is not in progress, e.g., by establishing a floor below which the DR event signal will not fall. Later, if the power utility calls for a demand response, the DR event signal will rise above this floor value and display driver 216 will present images that result in greater savings. In the alternative, a second method redefines the display driver mode employed for normal mode operation. In either case, the display driver 216 induces an energy savings when the DR event signal 223 indicates that a DR event is not in progress and increases energy savings when DR event signal 223 indicates that a DR event is in progress.

As can be seen, the present principles can provide a display driver able to selectably modify the energy consumption of direct-view emissive video displays while presenting video that is not entirely black.

As can be seen, the present principles can reduce the energy consumption of direct-view emissive video displays by selectively altering the drive applied to emissive sub-pixels based on the corresponding digital sub-pixel value provided to the driver circuit.

As can be seen, the present principles can reduce the energy consumption of direct-view emissive video displays by selectably altering the drive signal amplitude applied to emissive sub-pixels based on a corresponding digital sub-pixel value.

As can be seen, the present principles can reduce the energy consumption of video displays employing a spatial light modulator by selectably reducing the drive signal amplitude applied to an illumination element corresponding to a set of sub-pixels illuminated by the illumination element, where the drive signal amplitude is based on values corresponding to sub-pixels of the set, including those sub-pixels that can have been blanked.

As can be seen, when a demand response event is recognized, the present principles can reduce energy consumption of a direct-view emissive video display by selecting a mode of the display driver circuit wherein a portion of the sub-pixels of the display that would have been illuminated for the video content absent the demand response event are blanked during the demand response event.

As can be seen, embodiments of the present principles can reduce the energy consumption of video displays when a demand response event is recognized by the display drive circuitry altering the portion of the pixels or sub-pixels of the display that are illuminated relative to those the portion that would have been illuminated for the video information delivered to the display driver absent the demand response event and further pixels of the display representing the image, on average, being less brightly illuminated than those that would have represented the video content absent the demand response event.

As can be seen, embodiments of the present principles can receive demand response information via connection to a network, via wireless transmission, or via file, where the demand response information is a feed independent of any video stream.

As can be seen, embodiments of the present principles can receive demand response information in conjunction with a video stream, where the video stream is received via connection to a network, via wireless transmission, or via file.

As can be seen, embodiments of the present principles can reduce energy usage by an in-use video display in response to a smart home control signal or a user-preference.

As can be seen, embodiments of the present principles can consider the current time of day and/or policies in determining from demand response information received, whether a demand response event is in progress and what degree of reaction will be made to reduce energy consumption by the display.

As can be seen, the present principles can accept data representative of a request to lower power consumption, in some embodiments, as a signal separate from that of the video content, and in some embodiments, as a signal intermixed with the video content, e.g., as metadata.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the present principles unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the present principles. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 16 or means-plus-function claim format, and any claim without the terms “means for” is not so intended.

1. A device comprising:
an image processor, configured to receive a first video and produce a display-configured second video for a display, the second video based on the first video and including a set of pixels; and
a display driver, configured to receive the second video and transform the second video into drive signals for the display based on an active energy mode set by a selector in the device, the display driver having a plurality of selectable energy modes, the plurality of selectable energy modes comprising at least one reduced-energy mode and a non-reduced energy mode, each of the at least one reduced-energy mode blanking only perimeter-region pixels when selected, the display driver blanking no pixels when the non-reduced energy mode is selected.

2. The device of claim 1, wherein the selector is set according to a user preference.

3. The device of claim 2, further comprising:
a demand response processor responsive to demand response, DR, events, the demand response processor coupled to the selector and configured to set the selector so at least one first reduced-energy mode is active when a DR event is in progress.

4. The device of claim 3, wherein the at least one first reduced-energy mode blanks at least as many pixels as are blanked when the selector is set according to the user preference.

5. The device of claim 1, further comprising:
a demand response processor responsive to demand response, DR, events, the demand response processor coupled to the selector and configured to set the selector so the non-reduced energy mode is active when no DR event is in progress, the demand response processor configured to set the selector so a first reduced-energy mode is active when a DR event is in progress.

6. The device of claim 1, wherein the plurality of selectable energy modes comprises two different reduced-energy modes and the selector is configured to set zero, one, or two of the reduced-energy modes; wherein more pixels are blanked when the two reduced energy modes are selected than when only one of the two reduced-energy modes is selected, and not all of the pixels are blanked when the two reduced-energy modes are selected.

7. The device of claim 1, wherein the display driver comprises a plurality of display driver chips deployed parallel to a first axis of a display, comprising at least a first chip on a first edge of the display.

8. The device of claim 1, further comprising the display.

9. The device of claim 8, wherein the device is a television.

10. A method performed by a device, the method comprising:
producing a display-configured second video for a display, the second video based on a received first video and including a set of pixels; and
transforming the second video into drive signals for the display based on a set active energy mode selected from a plurality of selectable energy modes comprising at least one reduced-energy mode and a non-reduced energy mode, each of the at least one reduced-energy mode blanking only perimeter-region pixels when selected, the non-reduced energy mode blanking no pixels when selected.

11. The method of claim 10, wherein the active energy mode is set according to a user preference.

12. The method of claim 11, further comprising:
in response to a demand response, DR, event indicative of a DR event in progress, setting the active energy mode to at least one first reduced-energy mode.

13. The method of claim 12, wherein the at least one first reduced-energy mode blanks at least as many pixels as are blanked when the active energy mode is set according to the user preference.

14. The method of claim 10, further comprising:
in response to a demand response, DR, event, setting the energy mode so the non-reduced energy mode is active when no DR event is in progress and a first reduced-energy mode is active when a DR event is in progress.

15. The method of claim 10, wherein at least one combined energy mode comprises a combination of two different reduced-energy modes; wherein more pixels are blanked when the combined energy mode is active than when only one of the two different reduced-energy modes is active, and not all of the pixels are blanked when the combined energy mode is active.

16. The device of claim 1,
wherein the display driver is configured to transition gradually from the non-reduced energy mode to the reduced energy mode, when selected.

17. The device of claim 3, comprising:
a user interface configured to enable a user to set the demand response processor to select a second reduced-energy mode when no DR event is in progress, the second reduced-energy mode saving less energy than the first reduced-energy mode.

18. The device of claim 8, wherein the display is an LCD spatial light modulator-based display configured to dim backlight elements in the perimeter region in response to the perimeter-region pixels being blanked.
